(19) United States
(12) Patent Application Publication
(10) Pub. No.: US 2022/0030899 A1
(43) Pub. Date: Feb. 3, 2022

(54) VEGAN FERMENTED SOFT CHEESE

(71) Applicant: SAVENCIA SA, Viroflay (FR)

(72) Inventors: Fabien Durand, Razac sur L'Isle (FR); Virginie PADEL, FAVIERES (FR); Alice CIBRARIO, Versailles (FR)

(73) Assignee: SAVENCIA SA, VIROFLAY (FR)

(21) Appl. No.: 17/389,563

(22) Filed: Jul. 30, 2021

(30) Foreign Application Priority Data
Jul. 31, 2020 (FR) FR 2008199

(51) Int. Cl. A23C 20/00; A23L 33/115; A23L 33/125; A23L 33/185; A23L 29/00; A23L 29/212

(52) U.S. Cl. CPC A23C 20/005; A23L 33/115; A23L 29/212; A23L 33/185; A23L 29/06; A23L 33/125

(57) ABSTRACT

The present invention relates to a food product composed of vegetable ingredients having visual, textural and flavour properties of a soft fermented cheese.

The present invention relates to the field of the food industry; more specifically, it is aimed at the preparation of a food product composed of vegetable ingredients having visual, textural and aroma properties similar to those of a soft dough cheese.

Whether for ethical conviction or nutritional reasons, the demand for vegetarian or even vegan food products is constantly growing. There are, however, food products whose manufacture by definition requires the use of ingredients of animal origin, as in the case of mammalian milk for the preparation of cheese.

The applicant's objective is to develop a fermented vegetable food product composed of vegetable ingredients compatible with a vegan diet and similar to a dairy product of soft dough cheese type, in particular the soft dough refined such as Camembert, Brie, goat's log, etc.

The cheeses are a category of dairy products obtained from liquid milk, a colloidal medium composed of proteins of submicron size, lipid globules, sugars and mineral salts. The milk is potentially enriched with cream and then subjected to a thermal treatment (thermization or pasteurization) and/or physical treatment (microfiltration) in order to be coagulated enzymatically (rennet) and/or microbiologically (lactic acid bacteria in particular). The products are then demolded and refined to allow the development of a covering flora giving a fluffy appearance to the crust. Optionally, the crusts are processed by successive brushing and seeding in order to obtain products having specific characteristics such as colored crusts with more intense tastes.

The cheese analogues are defined as products obtained by mixing different ingredients such as proteins and fats, of dairy or non-dairy origin, and formulated to meet a specific functional need (Bachman, H. P., 2001, “Cheese analogues: a review”, International Dairy Journal, Volume 11, 505-515). Historically, these products have been formulated with an objective of reducing costs, in particular with the pizza cheeses. More recently, the segment of the vegetable analogues aiming to reproduce the appearance and taste characteristics of different cheeses has experienced a strong commercial expansion, and different products are available on the market with various formulation strategies.

For example, the vegetable analogues obtained by emulsifying fat in an aqueous phase containing starches are known, such as for example the Nurishh or Green Vie brand products. These products have a low protein content (less than or equal to 1%) and their texturing is ensured by the joint use of hard fat and modified starches or other hydrocolloid additives. These products are acidified using acidifiers such as lactic acid (E270) or citric acid (E330), or acidity regulators such as glucono-delta-lactone GDL (E575), with optional use of ferments. The above products have a smooth texture because they are based on the use of more or less purified ingredients in the form of powders of fine granulometry which are rehydrated and then emulsified with fat.

It is also possible to use vegetable juices (from soybean, lupines or nuts) obtained by dispersing vegetables, which are coagulated thermally or enzymatically and then the curd obtained is cut to extract the excess water, in the manner of the classic cheese-making process, comprising one or more steps of separation between the coagulated curd and the soluble whey. An example of the use of this method is described in EP3603407 (Barbieri). This method has two disadvantages in terms of material yield: on the one hand, the loss of the insolubles during the manufacture of vegetable juices and on the other hand, the loss of solubles during the separation of the curd with the whey. This method is therefore not advantageous in terms of material yield and generates at least two types of co-products (insolubles and whey).

Another embodiment is to implement whole or shelled seeds, optionally thermally treated, and to crush them before seeding them with lactic and/or refining ferments. The mixture is then molded to allow the mass of the pieces to set, which can then be demolded then refined. The seeds used are of several types: soybeans, lupins, cereals (oats, wheat, rice), etc. The prior art comprises many examples of applications involving the soybean and primarily the lacto-fermented soybean products such as the Tofu.

The same embodiment can also be applied to nuts, which have a composition close to that of the soybean. Among these nuts, the cashews nut are particularly used because they can be easily crushed into a paste using simple tools such as household appliances. This is illustrated by many pages on the internet offering recipes for cashew-based cheese analogues. For example, the following link https://www.lacuisinedannadolivia.com offers a recipe for a cheese analogue made from 100% cashew nuts, https://fullofplants.com/vegan-aged-camembert-cheese offers a recipe of 100% crushed cashew with ferments. The cashew is also the basis of many vegsetable commercial cheese analogues such as Happy Cashew, Les Nouveaux Affineurs, Jay & Joy, etc. These products contain a high proportion of cashew, between 30% and 70%, and an often short list of ingredients (cashew, water, salt, ferments type). They are usually obtained by fermenting a crushing of cashew, usually granular and more usually without significant addition of other ingredients. However, there are some special cases: the patent 20201281172A1 (Les Nouveaux Affineurs) teaches that a first crushing step is made, then adding the ferments and then performing a second crushing step. The additional addition of soybean to the cashew allows for example to obtain a product with a jelly-like texture, similar to that of a dairy product, which is exploited by the Les Nouveaux Affineurs brand. Indeed, the soybean is rich in proteins, which are known in the prior art for their texturizing properties.

Products containing mixtures of nuts such as cashew and macadamia (Camelia brand product), almond and cashew (Jay & Joy brand products) are also known. Marie Laforet in her book “Incroyable mais VEGAN” (published by Alternatives, 2019) also offers a recipe composed mainly of cashew associated with almond juice added with ferments.

However, most of the existing products remain far from the world of the refined dairy products: in terms of appearance, their color ranges from light to dark brown and the quality of the crust is unsatisfactory (inappropriate color, too heterogeneous with a tendency to peel off); the mouthfeel is often dry, not very melting and grainy, resembling more to a “pâté” rather than unctuous and melting dairy cheeses; finally, the organoleptic profile remains largely below expectations, with ammoniacal, yeasty or lipolyzed aromatic notes and acidic, bitter, pungent/burning flavors that do not correspond to the dairy reference.

Overall, the inability to sufficiently reproduce the attributes of the refined cheeses explains why the vegetable analogues are still emerging compared to more mature categories such as the dairy dessert analogues or the meat analogues, which are now in the domain of the mass consumption. This is in particular true for the vegetable analogues of soft dough cheese with a flowered crust, which are poorly represented on the market.

The objective of the applicant is to obtain a vegetable analogue of a fermented soft dough cheese and possibly refined from crushed nuts, having an organoleptic profile as close as possible to the dairy universe, in terms of its creamy color and its dairy aromatic notes.

By vegetable analogue of a soft dough cheese that is fermented and possibly refined, we mean a product formulated with vegetable raw materials that is as close as possible to refined cheeses of the Camembert, Brie or goat log type in terms of the appearance, the texture and the organoleptic profile. By fermented is meant a product acidified by fermentation with the help of lactic acid bacteria. By refined is meant a product that have a surface flora. In the following, the vegetable analogue food product of a soft dough cheese fermented and optionally refined according to the invention is referred to as a “vegetable food product analogous to a fermented cheese”.

Obtaining such products poses many technical problems.

Unlike the milk, which is a liquid, the vegetable materials are in the form of cohesive solids materials often organized in a complex manner with well-differentiated tissues having specific biological functions (e.g. germ and endosperm in a cereal).

Thus, due to these specific properties, it is difficult to prepare an unctuous, smooth and homogeneous (sub-millimeter scale) food product using only vegetable particles larger than a centimeter, which tend to give pasty and/or grainy products. The prior art offers two types of solutions: either the implementation of fine powders (starches and vegetable proteins) as mentioned above, or the implementation of finely crushed raw vegetable materials in order to obtain purees, also called “dough”, such as purees of nuts (cashew, almond, hazelnut, etc.) or of seeds such as soybean, lupin, etc. Such ingredients have been commercially available for a long time and have been used in this application.

Another difficulty is to completely free ourselves from animal raw materials, such as the dairy proteins or the eggs, whose binding properties could be used. In particular, it is difficult to replace the coagulant properties of the caseins, which allow the production of a curd that can then be refined.

It is also difficult to prepare a finished product without the additives often used in the vegetable products such as emulsifiers, gums and other hydrocolloids or the acids and acidity regulators used to lower the pH of the products and improve their preservation.

It is also difficult to obtain a product having a dairy or cheese typicity from vegetable raw materials, in particular the white color which allow to remind the universe of the cheese. This difficulty can be solved by combining a selection of the ingredients with the adaptation of the production method. Concerning the ingredients, the use of white powders such as starch, purified vegetable protein isolates and the use of coconut oil, which has a very white color, is known. The use of certain purees of nuts, in particular the pruned almond, which is particularly white, also allows to obtain an analogue of refined cheese optically resembling milk. It is also known that the use of the homogenization allows to make the food products (milk, emulsions, etc.) whiter.

Finally, it is difficult to obtain a fresh, dairy taste from vegetable materials and to preserve this fresh taste throughout the life of the product preservation, as this requires control of the stability of the product during the preservation and avoid the appearance of bad tastes or odors and the changes in texture. These are due to degradation phenomena such as proteolysis and lipolysis particularly difficult to control in the universe of the cheese analogues and which appear because of the small amount of sugars that can be metabolized by the ferments compared to the dairy products.

However, the applicant has succeeded in developing a fermented and/or refined food product that is entirely vegetable and that is similar to a cheese-type dairy product, both from the point of view of the product (visual, texture, aroma), with a white product with creamy notes and a flowered crust on the surface, and a fresh curd-type texture, and from the point of view of the manufacturing method (thermal treating, acidifying, curd-cutting or not, molding, demolding, and refining), thanks to a combination of formulation and method levers that allow to solve the above-mentioned technical problems.

Advantageously, the selection of vegetable raw materials and ferments, combined with a suitable manufacturing method, allows to offer products having an appearance characterized by a homogeneous flowered crust, well-furnished and white-colored and a creamy-yellow core. It also allows to offer products having a rheological behavior close to that of the dairy referents. It also allows to generate a moist and unctuous mouthfeel, which contrasts with the fatty or dry textures of certain products in the prior art, in particular cashew-based products. Finally, this selection allows to obtain a product having a taste that is close to the sensory universe of the dairy referents.

The applicant has selected finely crushed nut purees (median particle size less than 50 microns), purees which are essentially anhydrous and have a fluid consistency. Water has been added to these nut purees, both to allow the activation of the ferments and also to obtain a product with a moist and fresh mouthfeel, which is lacking in the products of the prior art. This addition of water results in a liquefaction of the almond puree, which was already fluid initially: the mixture thus obtained is very liquid, with a viscosity close to that of the milk. The structuring of this mixture is therefore a problem since the product must be textured within a few hours in order to make it demoldable and without the help of the caseins. In fact, in a dairy system, the coagulation of the milk is essentially made by the precipitation of the caseins. In the absence of the latter, it is therefore necessary to find a new approach to structure the product in order to make it solid. Three levers have been identified by the Applicant, which can be used alone or in combination to solve this technical problem:

The first structuring lever is to use an enzyme, the transglutaminase, to generate covalent bonds between the proteins allowing to form a gel. Impossible Foods in its patent EP2731451 mentions this technical solution for texturizing a nut milk, but it indicates that it is necessary to get rid of the insoluble matters and therefore to carry out a fractionation. The insoluble matters mentioned are carbohydrates that appear to interfere with the action of the transglutaminase. Surprisingly, the applicant has succeeded in texturizing a nut-based manufacturing mixture without any fractionation.

It was also found that not all nuts have the same reactivity to the transglutaminase. The almond is particularly advantageous because it generates a slightly firmer gel than other nuts. In addition, the pruned almond has a very white color, which is also a positive lever for obtaining a product that is closer to the dairy universe.
It may be necessary to inactivate the enzyme after the reaction is complete, in particular for regulatory reasons. This raises the technical problem of the modalities of inactivation of the enzyme and its impact on the finished product and its quality. For example, in the scope of an inactivation by thermal treatment, any degradation of the color of the product, of its texture and its organoleptic profile should be avoided. The time-temperature relationship was therefore studied in detail, in order to identify conditions that would allow the enzyme to be inactivated without significantly modifying the finished product. Preferably, a thermal treatment at a temperature below 80° C. gave satisfactory results. Examples of embodiments are described in Examples 1 and 2.

The second structuring lever is the addition of texturizing ingredients such as the use of sources of starch. The addition of starch, associated with a thermal treatment, allows in fact under certain conditions to structure the product sufficiently to ensure the demolding. This compensation is not without consequences and has led in particular to two new technical problems, one from a method point of view and the other from a product quality point of view:
At the method level, the addition of texturizing ingredients leads to an increase in the viscosity of the mixture at the time of the thermal treatment. A phase separation phenomenon can be observed under certain conditions, making the manufacture impossible for the following steps. The mixing parameters (speed, duration) and formulation (choice of the ingredients and their dosages) are therefore factors to be controlled. Another point concerns the flour-type ingredients, which are raw materials that are not very refined and therefore with relatively high levels of indigenous flora. From the point of view of the method and hygienic conditions, it will be important to control the thermal treatment conditions in order to have a significant reduction of the indigenous flora initially present in the manufacturing mixture.
At the product quality level, the addition of texturizing ingredients leads to an organoleptic degradation of the product with an increase in the undesirable tastes and odors (cardboard, green, hay, burnt, earthy) and a loss of whiteness. In fact, in addition to the vegetable notes and colorings that are classically more pronounced in ingredients such as flour or starch than in texturizing agents such as additives, the contents incorporated for a similar texturizing effect are much higher, which worsens the organoleptic defects of taste and color. It is then important to choose ingredients that allow to limit/remove these defects. This addition also leads to a greater evolution of the texture during the life of the product with in particular phenomena of retrogradation of the starch observed, synonymous with an increase in firmness during the preservation at 4-6° C. Preferably, the sources of starch used have been pregelatinized or precooked, which allows to improve their organoleptic profile (less green and raw vegetable notes) and their technological behavior during the method. It can be cereal flour, in particular rice or legume flour such as chickpea flour, lentils, broad beans, white beans, peas, fava beans, etc., and even pseudo-cereals such as quinoa, amaranth, buckwheat. It can also be native starch from wheat, corn or fecula as potato or manioc etc.

The third structuring lever consists of adding hard fats that will allow the solidification of the finished product during the crystallization of the fat. However, this lever must take into account the solubilization of the hard fat in the oil of the nut, which can be compensated for by adding more fat or by the implementation of one of the other two levers mentioned above. Then some hard fats such as the lauric fats can be responsible for undesirable tastes such as vomit, soap. It is therefore necessary to control and adjust the type of hard fat used depending on its fatty acid composition.

An example of combination of the latter two levers (sources of starch and hard fat) allowed to achieve the desired effect and is described in Example 5. The combination of the first and third levers (transglutaminase and hard fat) allowed to achieve the desired effect and is described in Examples 2 to 4.

In order to obtain a product having a taste close to the sensory universe of the dairy referents, the Applicant also had to select combinations of lactic ferments and possibly refining agents compatible with the manufacturing ingredients. By compatible is meant that the lactic and refining ferments are able to grow on the ingredients implemented. A detailed knowledge of the trophic needs of the species and strains is therefore essential, together with a detailed knowledge of the raw materials (sugar, amino acid and organic acid contents). These interactions have been studied in detail in the scope of the present application in order to offer the most appropriate strain/material combinations. One difficulty is to limit the degradation phenomena of the proteins and lipids during the refining in order to preserve a product having a taste close to the dairy universe. These phenomena are responsible for the appearance of the ammonia, yeast, vomit and soap type notes and are linked to the activity of the refining ferments. Indeed, in case of limitation of carbonaceous substrate (sugars or organic acids), the refining ferments will direct their metabolism towards the use of the proteins and the lipids as sources of energy and we thus speak about proteolysis and lipolysis. The evolution of the different compounds (sugars, organic acids and amino acids) during the manufacturing method should be known and followed.

Solutions to these problems are proposed:
On the one hand, a sufficient supply of carbonaceous substrate. This supply is achieved through the selection and the combination of ingredients in the manufacturing mixture. In particular, the nuts contain sugars, including sucrose, in small quantities, but which may be sufficient, and this is why this material is of interest in the scope of the invention.
On the other hand, a selection of fermentative strains adapted to the vegetable matrices. Indeed, within the same species and genus, significant variations in trophic needs, lipolytic and proteolytic behaviors can be observed. The selection of strains that metabolize vegetable carbohydrate components, with low proteolytic and lipolytic activity, is advantageous for acidifying the product and limiting the appearance of organoleptic defects during the preservation.
For example, for the acidification step, the lactic ferments have been selected according to their ability to consume and grow on certain sugars present in the vegetable domain such as sucrose, glucose, fructose, etc., and their acidifying activity. This is related to the decrease of the pH which is the reflection of the production of organic acids by the ferment. The acidifying activities were studied by a system of acquisition of pH measurement in real time, called CINAC® system (Spinnler H. E., Corrieu G., 1989. Automatic method to quantify starter activity based on pH measurement. Journal of Dairy Research, 56: 755-764). The strains that allow to acidify a nut juice in less than 12 hours at a temperature of between 30 and 40° C. for a target pH of less than 5.2 have been selected, they are part in particular of species such as Streptococcus thermophilus, Lactobacillus delbrueckii, Lactococcus lactis. Moreover, this rapid acidification below a pH of 5.2 has the advantage of limiting the development of the indigenous flora that having resisted the thermal treatment applied to the matrices.
During this step of lactic fermentation, lactate is produced, which is then used as a substrate for the refining ferments. Advantageously, the selection of the highly acidifying strains also allows to provide more organic acids to the refining ferments and to limit the lipolysis and proteolysis phenomena. This selection is also advantageous from the point of view of the food safety because the rapid acidification of the product limits the risk of contamination by pathogenic flora.
For example, for the refining step, the ferments were selected according to their degradation kinetics of the lactate. A slow kinetics is preferred and after 8 days of refining, a residual lactate content must be present in the product. Among these, those with low lipolytic and proteolytic capacities are preferred. These were determined by culturing the ferments on protein or lipid agar media and measuring in centimeters, at regular time intervals, the light zone around the colony reflecting the degradation of the proteins or lipids respectively, by the strain. The ferments for which the light areas were the least spread out were selected.

The present invention thus relates to a vegetable food product analogous to a fermented cheese, comprising:
crushed nuts, preferably in the form of puree, with the addition of:
at least transglutaminase and/or a source of starch;
lactic ferments; and
water;
characterized in that it does not contain soybeans or added food additives.

According to one embodiment, said vegetable food product analogous to a fermented cheese is refined.

According to another embodiment, at least one vegetable fat is added to said vegetable food product analogous to a fermented cheese.

In particular, the present invention relates to a vegetable food product analogous to a fermented cheese comprising:
crushed nuts, preferably in the form of puree and preferably almond puree;
   with the addition of:
optionally, at least one vegetable fat;
at least transglutaminase and/or a source of starch;
lactic ferments and optionally refining ferments;
optionally other ingredients such as aromas, sugar or calcium sources;
water;
   characterized in that it does not contain any added food additives, soybean or products derived from the soybean and preferably does not contain cashew.

By food additive is meant a substance added to the food for a technological purpose: to improve its preservation, to reduce the oxidation phenomena, to color the commodities, to reinforce its taste, etc., it can be coloring agents (including whitening agents), preservatives, antioxidants, acidifiers/acidity correctors and texture agents (stabilizer, emulsifier, thickener, gelling agent). The use of food additives is governed by the Regulation (EC) No 1333/2008 and these substances are identified by a code in the format “E” followed by a number.

More specifically, the present invention relates to a vegetable food product analogous to a fermented cheese prepared from the following ingredients (percentages expressed by weight based on the total weight of the product):
from 5 to 40%, preferably about 20%, or even about 25%, of crushed nuts; preferably in the form of a puree and preferably the particles of said puree are less than or equal to 50 μm in size;
optionally, up to 20% of vegetable fat, preferably 5 to 15% vegetable fat;
up to 1.5%, preferably about 0.5%, or about 1% of food salt;
from 0.01 to 0.5% of ferments, including for example lactic ferments and optionally refining ferments;
optionally, up to 3%, preferably about 1% of transglutaminase;
optionally, up to 15% of at least one vegetable ingredient such as a vegetable protein concentrate or isolate or inclusions;
optionally, up to 15% of at least one source of starch;
optionally, up to 8% of vegetable food fibres;
optionally, up to 5% of other ingredients such as aromas, source of sugars, source of calcium;
between 45% and 85%, preferably 70% or between 45 and 65% of water.

Nuts: the food product according to the invention consists of a base of one or more crushed nuts, for example selected from: almond, hazelnut, walnut, cashew, pecan nut, pine nut, Brazil nut, Macadamia nut, Queensland nut, Nangail nut, or peanut, alone or in a mixture; preferably, it is a nut puree, most preferably, a white almond puree. This puree must also be the result of a very fine crushing method (particle median size of less than 50 μm) and carried out on peeled and unroasted nuts. When this puree is prepared with almonds, such a puree has a particularly light color (compared to the roasted almond purees or other dried fruit purees) and a very neutral taste.

According to a preferred embodiment, the vegetable food product according to the invention is prepared with a whitened almond puree with particle sizes of less than 50 μm and allows the obtaining of a smooth and white texture. The choice of this raw material is also coupled with a mixing and shearing method that allows to offer smooth mouthfeels.

Depending on the desired firmness of the finished product, the almond puree content can be adjusted to reduce or increase the dry extract ad the fat and protein content.

Vegetable fat: the source of solid or liquid vegetable fat (which does not take into account the fat that may be comprised in the other ingredients) is incorporated to provide the melting characteristic in the case of vegetable oils, or the holding to the product in the case of solid fat. In addition to texture, the liquid oil/solid fat ratio also impacts the nutritional composition of the product, in particular the saturated fatty acid content.

A mixture of different vegetable fats can be used.

By way of example and without limitation, the oils may be sunflower, olive, grape seed or rapeseed; the solid fats (also known as hard fats) may be cocoa butter, dearomatized cocoa butter, shea butter or coconut oil.

In a particular embodiment, 10% cocoa butter is used.

Ferments: various ferments can be incorporated into the formulation and are known to the person skilled in the art. These may in particular include mesophilic lactic ferments (Lactococcus lactis ssp lactis and/or cremoris, Lactococcus lactis ssp lactis biovar diacetylactis, Leuconostoc lactis and/or Leuconostoc mesenteroides or pseudomesenteroides) or thermophilic (Streptococcus thermophilus, Lactobacillus delbrueckii ssp bulgaricus and/or Lacticaseibacillus casei and/or Levilactobacillus brevis and/or Lacticaseibacillus rhamnosus, and/or Lacticaseibacillus paracasei and/or Lactobacillus helveticus, Lactobacillus acidophilus), refining ferments of the type Geotrichum candidum or Penicillium camemberti and Brevibacterium linens or Hafnia alvei or of the genus Propionibacterium or Pediococcus pentosaceus, Laciplantibacillus plantarumand finally also yeasts such as Kluvyeromyces lactis or Debaromyces hansenii, alone or in mixture. In particular, commercial products such as lactic ferments from the Yoflex® (Chr Hansen) can be used.

The ferments can be added either directly in the form of concentrates at a content of 0.01 to 0.5% during the seeding, or in the form of a leaven composed of a fermented vegetable raw material and one or more ferments in concentrated form; the refining ferments can be mixed into the mass of the product during its preparation (in direct or leavened form) or sprayed onto the demolded product just prior to the refining phase.

By way of illustration without limitation, the fermented vegetable food product may be prepared with 0.01% lactic ferments (S. thermophilus and L. bulgaricus) and 0.1% Geotrichum candidum or with 0.1% lactic ferment (Lactocococcus lactis) and 0.1% Penicillium camembertii.

The selected ferments preferably have the metabolic properties described above.

Transglutaminase: the use of a transglutaminase allows to have a firmer, more melting product; this enzyme catalyzes the formation of covalent bonds between free amine groups, for example those of lysine residues, and the gamma carboxamide group of the glutamine residues, thus allowing the cross-linking of the proteins present in the nut or seed puree. Its use is optional and it is possible to obtain a product according to the invention without the use of this coagulating enzyme. Various transglutaminases are available on the market.

Vegetable ingredient: one or more vegetable ingredients can be added:
Inclusions to play with contrasts in texture (seeds, fruit or vegetable inclusions), color (herbs, seasoning, etc.);
Vegetable protein sources such as concentrates or isolates, in particular from legumes (green or red lentils, beans, etc.) or oilseeds (rapeseed, sunflower, hemp, etc.), which allow to modify the nutritional profile of the finished product or to add color.

Sources of starch: such as cereal and pseudo cereal flours, legumes or fecula and other starches. These flours contain a significant amount of starch, which allows to add functionality to the finished product.

As mentioned above, preferably the sources of starch used have been pregelatinized or precooked, which allows to improve their organoleptic profile (less green and raw vegetable notes) and their technological behavior during the method. It can be cereal flour, in particular rice or legume flour such as chickpea flour, lentils, broad beans, white beans, peas, fava beans, etc., and even pseudo-cereals such as quinoa, amaranth, buckwheat. It can also be native starch from wheat, corn, or fecula as potato or manioc.

Vegetable food fibres: these are food fibres, i.e. non-digestible carbohydrates extracted for example from wheat, oats, barley, peas, lupines, fruits, in particular apples or citrus fruits, chicory, psyllium or even resistant dextrins. The food fibres allow to improve the nutritional profile of the finished product and in some cases contributes to the firmness of the product or its mouthfeel. The food fibres which can be used in the scope of the invention are preferably soluble fibres with low texturizing properties such as chicory fibres (inulins and fructooligosaccharides), resistant dextrins or any other indigestible oligosaccharide of vegetable origin, having a neutral taste, a high solubility in water and a limited tendency to recrystallization. The soluble fibres known as texturizing or viscosifying fibres can also be used but at lower levels as they can give a slightly too firm or stringy texture. Finally, the insoluble or partially soluble fibres can also be used provided that they have a particle size and shape that makes them undetectable in the mouth and a low water retention capacity; preferably, the soluble fibres with low texturizing properties are used.

A mixture of several vegetable food fibres can be used.

In particular inulin (chicory fibres) can also be added to the products where a melting and unctuous texture is desired.

The choice of the reference and the origin of the fibres can have impacts on the texture and the taste that the person skilled in the art can adjust according to his objectives and preferences.

Other ingredients: other ingredients are ingredients used in small quantities in the finished product but which may have a significant impact on its properties and its qualities. For example, at least natural aromas can be added to either mask the undesirable vegetal aromatic notes or to increase the typicity of the product. It is also possible to add a natural source of calcium such as the lithothamnion which is a red algae known for its high calcium carbonate content. Finally, it may be desirable to add sugars and/or vegetable oligosaccharides such as dextrose, sucrose, fructose or glucose-fructose syrup, cereal syrup (rice, oats, sorghum) or fruit syrup or extracts.

According to an embodiment, the vegetable food product analogous to a fermented cheese according to the invention is prepared from the following ingredients:
from 5 to 40%, preferably about 20%, or even about 25%, of crushed nuts; preferably in the form of a puree and preferably the particles of said puree are less than or equal to 50 μm in size;
up to 20% of vegetable fat, preferably 5 to 15% of vegetable fat;
up to 1.5%, preferably about 0.5%, or about 1% of food salt;
from 0.01 to 0.5% of ferments, including for example lactic ferments and optionally refining ferments;
up to 3%, preferably about 1% of transglutaminase;
optionally, up to 15% of at least one vegetable ingredient such as a vegetable protein concentrate or isolate or inclusions;
optionally, up to 15% of at least one source of starch;
optionally, up to 8% of vegetable food fibres;
optionally, up to 5% of other ingredients such as aromas, source of sugars, source of calcium;
between 45% and 85%, preferably 70% or between 45 and 65% of water.

According to another embodiment, the vegetable food product analogous to a fermented cheese according to the invention is prepared from the following ingredients:
from 5 to 40%, preferably about 20%, or even about 25%, of crushed nuts; preferably in the form of a puree and preferably the particles of said puree are less than or equal to 50 μm in size;
optionally, up to 20% of vegetable fat, preferably 5 to 15% of vegetable fat;
up to 1.5%, preferably about 0.5%, or about 1% of food salt;
from 0.01 to 0.5% of ferments, including for example lactic ferments and optionally refining ferments;
optionally, up to 15% of at least one vegetable ingredient such as a vegetable protein concentrate or isolate or inclusions;
up to 15% of at least one source of starch;
optionally, up to 8% of vegetable food fibres;
optionally, up to 5% of other ingredients such as aromas, source of sugars, source of calcium;
between 45% and 85%, preferably 70% or between 45 and 65% of water.

The present invention thus relates to a vegetable food product analogous to a fermented cheese comprising (percentages expressed by weight based on the total weight of the product):
from 5 to 52%, preferably between 5 and 30%, about 20% or even 25%, of crushed nuts; preferably in the form of a puree and preferably the particles of said puree have a size less than or equal to 50 μm;
optionally, up to 26% of at least one vegetable fat;
0.5 to 2.5%, preferably about 1.5%, of food salt;
optionally up to 20% of a vegetable ingredient such as a vegetable protein concentrate or isolate or inclusions;
optionally, up to 20% of at least one source of starch;
optionally up to 10% of vegetable food fibres;
optionally, up to 7% of other ingredients such as aromas, source of sugars, source of calcium;
between 35% and 75%, preferably 70% or between 45 and 65%, water.

TABLE 1
Nutritional characterization of the fermented
product according to the invention
Content per 100 g

| | |
|---|---|
| Dry extract | 25-65 |
| Protein | 1-20 |
| Carbohydrates | 0.5-20 |
| Lipids | 3-40 |
| Fibres | 0.5-10 |

This product is characterized by characteristics of a dairy product in particular, an appearance reminiscent of the dairy universe with a very white surface flora and a white to beige paste, a firmness close to that of the dairy universe and fresh and little vegetal aromatic notes.

Color analysis of paste was carried out in comparison to commercially refined soft dough cheeses and are reported in Example 6.

Rheological analyses were also carried out and are reported in Example 7.

A sensory comparison was also conducted and is reported in Example 8. The products of the invention are characterized by a lower overall intensity than the products of the competition. They are less cheesy/lipolyzed, less fermented/yeasty, less refined, less acidic and more dairy.

Advantageously, this product is composed of vegetable ingredients and is therefore suitable for the people following a vegetarian or vegan diet. Furthermore, it does not contain any milk-derived products such as proteins and lactose and is therefore suitable for the consumers with milk allergies or intolerances. This product contains less saturated fatty acids than a dairy product and is cholesterol free; it does not contain any preservatives (such as potassium sorbate) or food additives. Its energy value is lower than that of the traditional soft dough. In addition, this product has good organoleptic qualities as illustrated in the following examples.

The vegetable food product analogous to a refined cheese according to the invention can be prepared according to the following method (also shown in Table 2):

A) mixing the ingredients and obtaining a pumpable mix;

The purpose of this step is to prepare a mixture of the various ingredients excluding the ferments (e.g. water, nut puree, fat, salt, vegetable ingredients (flours, concentrates, isolates, source of starch), vegetable fibres and other ingredients (aromas, sugar source, etc.), all these ingredients being as defined above) so as to obtain a globally liquid suspension; it may be lead at a temperature of between 20 and 70° C., for 10 to 30 minutes and under moderate to high shear and can be carried out by hand, with a mixer, a dynamic mixer or a cooker. According to a preferred embodiment, this mixing step is performed with a cooker, for 10 minutes at 50° C. under moderate shear and then 1 minute at high shear.

B) optionally, homogenizing the mixture obtained in step A);

The purpose of this step is to reduce the particle size, allowing thus to improve the firmness of the products by means of a high shear mixer (ultra-turrax, colloidal mill, etc.) or a counter-pressure homogenizer, operating in a pressure range of between 50 and 600 bar.

C) heating to between 75° C. and 100° C. for 5 to 30 minutes, preferably to about 80° C. for 20 minutes or to about 85° C. for 20 minutes;

This step allows the sanitation (elimination of undesirable microorganisms) of the manufacturing mixture for its preservation; it also leads to a denaturation of the vegetable proteins favorable to the action of the transglutaminase when it is present and to the functionalization of the ingredients, in particular for the source of starch ingredients.

D) cooling to a temperature of about 40° C., preferably between 35 and 45° C.;

E) seeding the ferments in concentrated form and/or leaven and optionally transglutaminase under agitation in order to allow their good distribution within the mixture;

F) optionally, coagulating;

In the case where a transglutaminase has been incorporated into the mixture, the holding at a lowered temperature (between 30 and 60° C.) may be prolonged up to 3.5 hours to allow the enzymatic action of the transglutaminase; preferably, the action of the transglutaminase, which allows the formation of a gel favoring the slicing of the finished product, is allowed by a holding at about 40° C. for about 1.5 hours.

G) optional curd-cutting followed by a molding;

This step allows to give a shape to the product; it can be led by molding after curd-cutting or molding directly;

H) acidifying by fermentation for 7 to 20 hours at about 30° C., preferably at a temperature of between 30 and 45° C. and even more preferably 16 to 20 hours at 37° C., until a pH of between 5.2 and 4.5 and preferably between 5.2 and 4.2 is reached;

This step is made spontaneously by action of the lactic ferments such as those used in the manufacture of yoghurt or any other seeding ferment known to the person skilled in the art. Preferably, the lactic ferment is a lactic ferment of the Yoflex® type (Chr. Hansen) or other (at 0.01%), the acidification lasts about 7 hours and allows to reach a pH of about 5.2.

This step also allows to add an aromatic note or to reinforce the texture via the fermentation; for example, the ferments can be Lactococcus lactis, Pediococcus pentosaceus, Lactobacillus plantarum or the propionic bacteria or the yeasts.

I) optionally, thermal treating to inactivate the transglutaminase.

The core temperature of the product should be below 90° C. and preferably between 70 and 80° C.

J) demolding;

K) optionally, spraying the refining ferments;

L) optionally, dry salting;

M) optionally, refining;

That is to say, the development of a surface flora (Geotrichum, Penicillium), which is white, flat, not very aromatic and stable over time. This step is done cold (3-12° C.) for 3 to 20 days until a well flowered crust is obtained. Preferably, it is carried out with 0.1% Geotrichum candidum for 10 days at 8° C.

N) preserving between 4 and 10° C.

The preservation of the finished product can be carried out in any packaging conventionally used for the dairy products.

TABLE 2

| | | | | Preferred value |
|---|---|---|---|---|
| | | | | implemented in |
| | | | | the experimental |
| | Unitary step | Interest | Tested values | part |
| A | Mixing the | Mixing the | Mixing temperature | Cooker, mixing |
| | ingredients and | different | between 20 and 70° C. | 10 min at 50° C. at |
| | obtaining a | ingredients so as to | Mixing time between | 1500 rpm |
| | pumpable mix | obtain a globally | 10 and 30 min | |
| | | liquid suspension | Speed 200 and 10000 | |
| | | | rpm | |
| B | Homogenizing | Stable emulsion, | 50 to 600 bar | 300-500 bar |
| | (optional step) | particle size | | |
| | | reduction for smooth | | |
| | | texture and texturing | | |
| | | lever | | |
| C | Thermal treating | Sanitazing the | 75° C. to 90° C. | 85° C./20 min |
| | | manufacturing mix | 5 to 30 minutes | |
| | | for the preservation | | |
| | | Denaturating the | | |
| | | almond proteins to | | |
| | | allow the | | |
| | | transglutaminase to | | |
| | | act | | |
| | | Functionalizing | | |
| | | sources of starch | | |
| D | Cooling | Reaching an | 35-50° C. | around 40° C. |
| | | acceptable | | |
| | | temperature for the | | |
| | | addition of the | | |
| | | ferments | | |
| E | Seeding (ferments | Adding ferments | Ferments: 0.01; 0.5% | |
| | and/or leavens, | and optionally | Transglutaminase: 0-3% | |
| | and/or coagulating | transglutaminase | | |
| | agent) | | | |
| F | Coagulating by | Creating a gel to be | Temperature between | 1%, 1 h 30 at 40° C. |
| | transglutaminase | able to slice it | 30° C. and 60° C. up to | |
| | (optional step) | | 3 h 30 | |
| G | Optional curd- | Giving a shape to | | |
| | cutting and molding | the product | | |
| H | Acidifying | Health and Safety | Low pH between 5.2 | 16 to 20 hours at |
| | | | and 4.2 | 37° C. |
| | | | Acidifying of 7 h and | |
| | | | 20 h at a temperature | |
| | | | of about 30° C. | |
| I | Thermal treating of | Inactivation of the | <90° C. at core | Between 70 and |
| | the finished product | transglutaminase, | | 80° C. |
| | (optional step) | | | |
| J | Demolding | | 4-15° C. | 10° C. |
| K | Spraying covering | | | |
| | ferments | | | |
| | (optional step) | | | |
| L | Dry salting | | | |
| | (optional step) | | | |
| M | Refining | Development of a | Temperature between | 10 D at 8° C. |
| | (optional step) | flower with a very | 4 and 15° C. | |
| | | white surface, flat, | Duration from 3 to 20 | |
| | | not very aromatic, | days | |
| | | stable over time | | |
| N | Storage | Preservation | | 4° C. |

### FIGURES

FIG. 1 represents the product according to the invention obtained at the end of example 2.

FIG. 2 represents the product according to the invention obtained at the end of example 3.

FIG. 3 represents the average dE values obtained for the products of the invention and the commercial soft dough dairy products.

FIG. 4 represents the Young's modulus values of a selection of fermented and refined dairy cheeses and products according to the invention.

FIG. 5 represents the map of the products resulting from the sensory evaluation.

FIG. 6 represents the map of the sensory descriptors.

FIG. 7 represents the results of the sensory evaluation of the products of the invention and of commercial products.

### EXAMPLES

Example 1: In this example, the product according to the invention is prepared with 30% almond puree, 5% rapeseed oil, 5% wheat flour, 0.5% NaCl, 0.01% commercial ferments of type Yoflex® (Chr. Hansen), 0.1% Geotrichum candidum, 1% transglutaminase and water amount sufficient to 100%.

The steps implemented are as follows: A-C-D-E-F-G-H-I-J-K-L-M-N (see Table 2)

The finished product having the appearance of a dairy soft dough, with a white flowered crust and a smooth and homogeneous core having a melting texture.

The product has a pH of 4.6 and can be preserved for several weeks at a temperature of 4 to 10° C. without showing any noticeable change in texture or taste or flora balance.

The nutritional values of the product in Example 1 are shown below:

TABLE 3
Content per 100 g

| | |
|---|---|
| Energy (kcal) | 247 |
| Dry extract | 45 |
| Protein | 8 |
| Carbohydrates | 6 |
| Of which sugars | 1.3 |
| Lipids | 21 |
| Fibres | 3 |

Example 2: Product prepared with 10% almond puree, 10% cocoa butter, 10% pea protein isolate, 0.5% NaCl, 0.01% Yoflex® (Chr.Hansen) commercial ferments, 0.1% Geotrichum candidum, 1% transglutaminase and water amount sufficient to 100%.

The steps implemented are as follows: A-C-D-E-F-G-H-I-J-K-M-N (see Table 2).

The product of Example 2 has a firmer texture than the product of Example 1 and is slightly drier in the mouth. The color is also slightly darker due to the addition of the pea protein and the taste is slightly more distinctive (see FIG. 1).

The nutritional profile is also modified as shown in the following table:

TABLE 4
Content per 100 g

| | |
|---|---|
| Energy (kcal) | 249 |
| Dry extract | 40 |
| Protein | 12 |
| Carbohydrates | 1.1 |
| Of which sugars | 0.6 |
| Lipids | 20.5 |
| Fibres | 1.7 |

Example 3: Product prepared with 20% almond puree, 10% cocoa butter, 0.5% NaCl, 0.01% Yoflex® (Chr.Hansen) commercial ferments, 0.1% Geotrichum candidum, 1% transglutaminase and water amount sufficient to 100%.

The steps implemented are as follows: A-C-D-E-F-G-H-I-J-K-M-N (see Table 2).

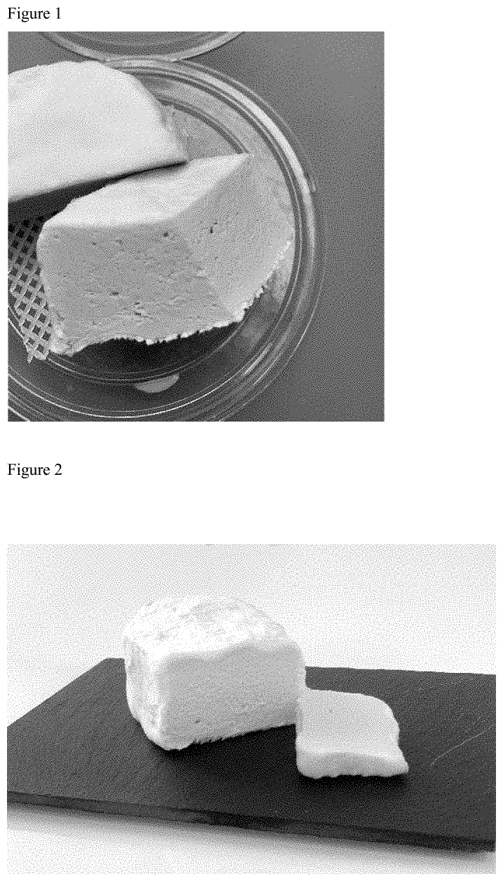

The finished product has a fresh, melting texture, a white chalky core with the appearance of a dairy soft dough, with a white flowered crust. The product has a pH of 4.6 and can be preserved for several weeks at a temperature of 4 to 10° C. without showing any noticeable evolution in terms of texture or taste or flora balance (see FIG. 2).

The nutritional values of the product in Example 3 are shown below:

TABLE 5
Content per 100 g

| | |
|---|---|
| Energy (kcal) | 280 |
| Dry extract | 40 |
| Protein | 5.6 |
| Carbohydrates | 2.1 |
| Of which sugars | 1.3 |
| Lipids | 27 |
| Fibres | 2.7 |

Example 4: Product composed of 20% almond puree, 10% cocoa butter, 1% glucose syrup, 0.5% NaCl, 0.1% commercial lactic ferments, 0.1% Penicillium camembertii, 1% transglutaminase and water amount sufficient to 100%.

The steps implemented are as follows (see Table 2):

A-C-D-E-G without curd-cutting-H-I-J-K-M-N

The mix is directly molded in jars, the coagulation is done at the same time as the acidification during the step H, this step is conducted from 16 to 20 hours at 30° C.

The finished product has a more homogeneous, smoother and more gel-like texture, having the appearance of a dairy soft dough, with a very white, fluffy flowered crust and with a slight note of mushroom. The product has a pH of 4.6 and can be preserved for several weeks at a temperature of 4 to 10° C. without showing any noticeable change in texture or taste or flora balance.

The nutritional values of the product in Example 4 are shown below:

TABLE 6
Content per 100 g

| | |
|---|---|
| Energy (kcal) | 212 |
| Dry extract | 35 |
| Protein | 4.2 |
| Carbohydrates | 2.5 |
| Of which sugars | 2 |
| Lipids | 21 |
| Fibres | 2.0 |

Example 5: Product composed of 22% almond puree, 10% cocoa butter, 5% rice flour, 5% potato fecula 1% NaCl, acidification by commercial ferments, 0.1% Geotrichum candidum and water amount sufficient to 100%.

The method selected for the example comprises the following steps (see Table 2): A-C-D-E-G without curd-cutting-H-J-M-N

The finished product has the appearance of a refined dairy product, with a white crust and a firm, melting, sliceable core and a beige-colored paste. The product has a pH of 4.5 and can be preserved for several weeks at a temperature of 4 to 10° C. without showing any noticeable change in texture or taste or flora balance.

The nutritional values of the product in Example 5 are shown below:

TABLE 7
Content per 100 g

| | |
|---|---|
| Energy (kcal) | 250 |
| Dry extract | 45 |
| Protein | 5 |
| Carbohydrates | 9 |
| Of which sugars | 1.3 |
| Lipids | 22 |
| Fibres | 2 |

### Example 6

CIELAB colorimetry analyses were performed on commercial dairy soft dough products and on some examples related to our invention. The measurement was performed only on the core of the product (the paste).

CIE Lab (more exactly L*a*b*) is a model of representation of the colors developed in 1976 by the International Commission of Lighting (CIE). Like all the devices from the CIE XYZ device, it characterizes a color with an intensity parameter corresponding to the luminance and two chrominance parameters that describe the color. It has been particularly studied so that the calculated distances between colors correspond to the differences perceived by the human eye.

The combination L* is the lightness, which ranges from 0 (black) to 100 (white).

The a* component represents the range from the red (positive value) green (negative) axis passing through the white (0) if the brightness is 100.

The b* component represents the range from the yellow (positive value) blue (negative) axis passing through the white (0) if the brightness is 100.

The L*a*b* color model was created as an absolute model, independent of the equipment that can be used as a theoretical reference. The dE criterion was followed, this is a calculation that measures the deviation from white (Color in Food: Improving Quality, published by D MacDougall in 2002) according to the following equation:

ΔE*=[(ΔL*)²+(Δa*)²+(ΔLb*)²]^{1/2}

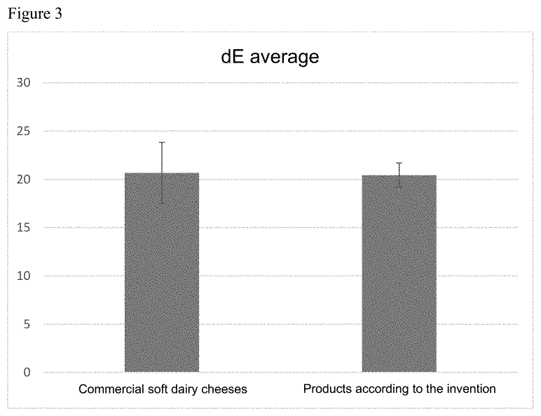

FIG. 3 shows the average dE values obtained for the products of the invention and commercial dairy soft dough products; it shows that the products of the invention are in the color universe of the commercial dairy soft dough products with an average dE of about 20.

### Example 7

The rheological characterization of the cheeses was carried out using an Instron universal traction-compression machine. The products are placed on a plane and their initial diameter is measured. They are subjected to an uniaxial compression by a plate whose diameter is greater than that of the cheese. The plate descends at a constant speed of 30 mm/min to a displacement corresponding to 15% of the initial height of the product.

The resistive force, normalized by the initial diameter of the cheese, is homogeneous to an apparent stress (in kPa). The displacement of the plate after contact, referred to the initial height, is homogeneous to an apparent deformation (without units). The apparent stress initially varies linearly with the apparent deformation. The slope (i.e. the ratio between apparent stress and deformation) corresponds to the apparent Young's modulus (noted E, in kPa), which is an indicator of the firmness of the product.

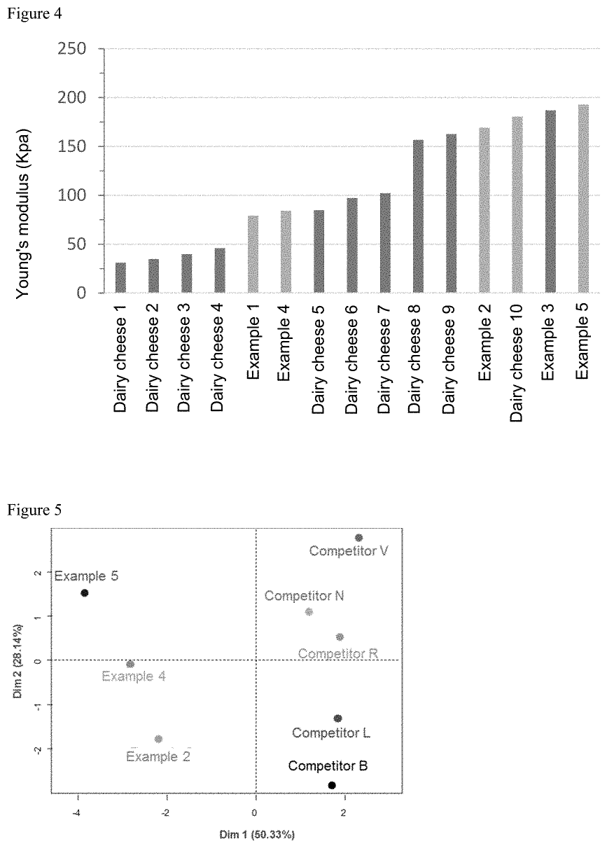

This test was conducted on a selection of fermented and refined dairy cheeses (Camembert, goat's cheese, etc.) and on some products according to the invention. The Young's modulus values obtained are shown in FIG. 4.

The values obtained for the products in the various examples are of the same order of magnitude as those for various dairy cheeses. The combination of the different technical levers described above therefore allows to generate a product space that reproduces the rheological attributes of different fermented and/or refined dairy cheeses.

### Example 8

A sensory evaluation was conducted on some examples of the invention against commercially available refined VEGAN products. The products shown in examples 2-4 and 5 were evaluated against commercial products named competitor B, L, R, N, V.

The evaluation took place in a comparative way, on products presented anonymously with the help of a 3-digit code, the product is evaluated as a whole, i.e. a piece comprising both the paste and the crust.

The jury was made up of 8 participants trained in the descriptive method (Sensory Profile/QDA Quantitive Descriptive Analysis) and in the evaluation of vegetable products.

About ten descriptors were evaluated, including: Overall Intensity, Dairy, Cheesy/Lipolyzed, Yeasty/Fermented, Refined and Acidic.

The products were rated on a 6-point discontinuous scale (0=no perception to 5=very strong perception).

The results are presented in the form of a PCA (Principal Component Analysis) which allows the sensory differences observed to be summarized. The PCA is presented in the form of 2 graphs to be interpreted simultaneously.

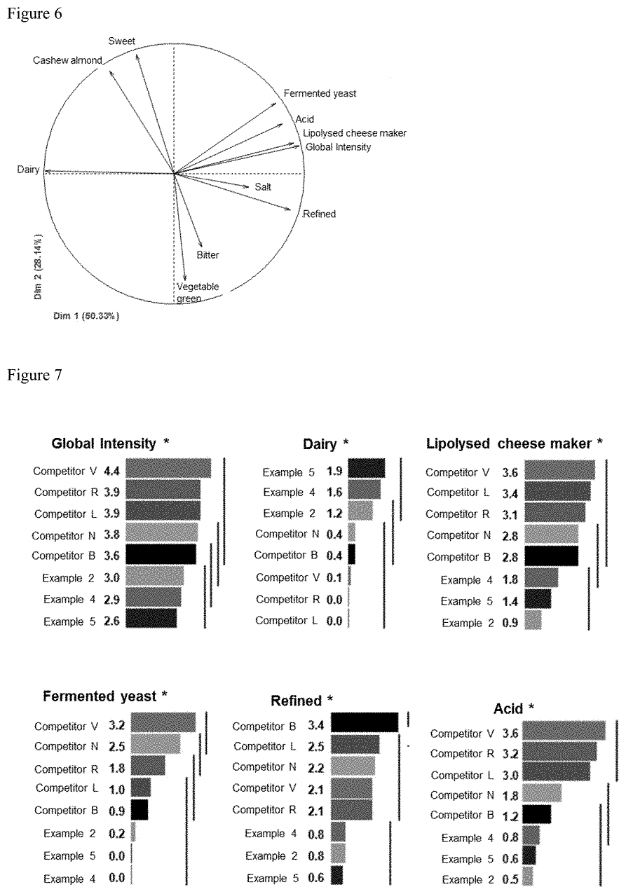

The map of the products indicates the sensory proximities between products and the map of the descriptors allows to interpret them: a product is located in the direction of the descriptors for which it has high values, relative to the other products on the map (see FIGS. 5 and 6).

At the end of the sensory evaluation, the products of the invention stand out with a lower overall intensity than the products of the competition. They are less cheesy/lipolyzed, less fermented/yeasty, less refined, less acidic and more dairy (FIG. 7).

1. A vegetable food product analogous to a fermented cheese comprising:
crushed nuts, with the addition of:
at least transglutaminase and/or a source of starch;
lactic ferments; and
water,
wherein the vegetable food product does not contain soybeans or added food additives.

2. The vegetable food product according to claim 1, wherein the vegetable food product is refined.

3. The vegetable food product according to claim 1, to which at least one vegetable fat is added.

4. The vegetable food product according to claim 1, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally up to 3% of transglutaminase;
optionally up to 15% of a vegetable ingredient, including a vegetable protein concentrate or isolate or inclusions;
optionally, up to 15% of at least one source of starch;
optionally up to 8% of vegetable food fibres;
optionally up to 5% of other ingredients, including aromas, sugar or calcium sources; and
between 45% and 85% of water.

5. The vegetable food product according to claim 1, prepared from the following ingredients (percentages expressed by weight based on the total weight of the product):
5 to 40% of crushed nuts; the nut particles are less than or equal to 50 μm in size;
up to 20% of vegetable fat;
up to 1.5% of food salt;
from 0.01 to 0.5% of lactic ferments and optionally refining ferments;
up to 3% of transglutaminase;
optionally, up to 15% of at least one vegetable ingredient, including a vegetable protein concentrate or isolate or inclusions;
optionally, up to 15% of at least one source of starch;
optionally, up to 8% of vegetable food fibres;
optionally, up to 5% of other ingredients, including aromas, a source of sugars, ora source of calcium; and
between 45% and 85% of water.

6. The vegetable food product according to claim 1, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally, up to 15% of at least one vegetable ingredient, including a vegetable protein concentrate or isolate or inclusions;
up to 15% of at least one source of starch;
optionally, up to 8% of vegetable food fibres;
optionally, up to 5% of other ingredients, including aromas, a source of sugars, ora source of calcium; and
between 45% and 85% of water.

7. The vegetable food product according to claim 1 comprising (percentages expressed by weight with respect to the total weight of the product):
5 to 52% of crushed nuts; the nut particles are less than or equal to 50 μm in size;
optionally, up to 26% of vegetable fat;
0.5 to 2.5% of food salt;
optionally up to 20% of a vegetable ingredient, including a vegetable protein concentrate or isolate or inclusions;
optionally, up to 20% of at least one source of starch;
optionally up to 10% of vegetable food fibres;
optionally up to 7% of other ingredients, including aromas, sugar or calcium sources; and
between 35% and 75% of water.

8. The vegetable food product according to claim 1, wherein the vegetable food product has the following nutritional composition:
Content per 100 g

| | |
|---|---|
| Dry extract | 25-65 |
| Protein | 1-20 |
| Carbohydrates | 0.5-20 |
| Lipids | 3-40 |
| Fibres | 0.5-10 |

9. A method for preparing the vegetable food product according to claim 1, comprising the steps of:
A) mixing the ingredients and obtaining a pumpable mix;
B) optionally, homogenizing the mixture obtained in step A);
C) heating between 75° C. and 90° C. for 5 to 30 minutes;
D) cooling to a temperature of about 40° C.;
E) seeding the ferments, optionally adding transglutaminase;
F) optionally, coagulating;
G) optional curd-cutting followed by a molding;
H) acidifying by fermentation for 7 to 20 hours at about 30° C., until a pH of between 5.2 and 4.5 is reached;
I) optionally, thermal treating;
J) demolding;
K) optionally, spraying the refining ferments;
L) optionally, dry salting;
M) optionally, refining; and
N) preserving.

10. The vegetable food product according to claim 1, wherein the crushed nuts are in the form of a puree.

11. The vegetable food product according to claim 2, to which at least one vegetable fat is added.

12. The vegetable food product according to claim 2, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally up to 3% of transglutaminase;
optionally up to 15% of a vegetable ingredient, including a vegetable protein concentrate or isolate or inclusions;
optionally, up to 15% of at least one source of starch;
optionally up to 8% of vegetable food fibres;
optionally up to 5% of other ingredients, including aromas, sugar or calcium sources; and
between 45% and 85% of water.

13. The vegetable food product according to claim 3, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally up to 3% of transglutaminase;
optionally up to 15% of a vegetable ingredient, including a vegetable protein concentrate or isolate or inclusions;
optionally, up to 15% of at least one source of starch;
optionally up to 8% of vegetable food fibres;
optionally up to 5% of other ingredients, including aromas, sugar or calcium sources; and
between 45% and 85% of water.

14. The vegetable food product according to claim 2, prepared from the following ingredients (percentages expressed by weight based on the total weight of the product):
5 to 40% of crushed nuts; the nut particles are less than or equal to 50 μm in size;
up to 20% of vegetable fat;
up to 1.5% of food salt;
from 0.01 to 0.5% of lactic ferments and optionally refining ferments;
up to 3% of transglutaminase;
optionally, up to 15% of at least one vegetable ingredient, including a vegetable protein concentrate or isolate or inclusions;
optionally, up to 15% of at least one source of starch;
optionally, up to 8% of vegetable food fibres;
optionally, up to 5% of other ingredients, including aromas, a source of sugars, or a source of calcium; and
between 45% and 85% of water.

15. The vegetable food product according to claim 3, prepared from the following ingredients (percentages expressed by weight based on the total weight of the product):
5 to 40% of crushed nuts; the nut particles are less than or equal to 50 μm in size;
up to 20% of vegetable fat;
up to 1.5% of food salt;
from 0.01 to 0.5% of lactic ferments and optionally refining ferments;
up to 3% of transglutaminase;
optionally, up to 15% of at least one vegetable ingredient, including a vegetable protein concentrate or isolate or inclusions;
optionally, up to 15% of at least one source of starch;
optionally, up to 8% of vegetable food fibres;
optionally, up to 5% of other ingredients, including aromas, a source of sugars, or a source of calcium; and
between 45% and 85% of water.

16. The vegetable food product according to claim 4, prepared from the following ingredients (percentages expressed by weight based on the total weight of the product):
5 to 40% of crushed nuts; the nut particles are less than or equal to 50 μm in size;
up to 20% of vegetable fat;
up to 1.5% of food salt;
from 0.01 to 0.5% of lactic ferments and optionally refining ferments;
up to 3% of transglutaminase;
optionally, up to 15% of at least one vegetable ingredient, including a vegetable protein concentrate or isolate or inclusions;
optionally, up to 15% of at least one source of starch;
optionally, up to 8% of vegetable food fibres;
optionally, up to 5% of other ingredients, including aromas, a source of sugars, or a source of calcium; and
between 45% and 85% of water.

17. The vegetable food product according to claim 2, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally, up to 15% of at least one vegetable ingredient, including a vegetable protein concentrate or isolate or inclusions;
up to 15% of at least one source of starch;
optionally, up to 8% of vegetable food fibres;
optionally, up to 5% of other ingredients, including aromas, a source of sugars, or a source of calcium; and
between 45% and 85% of water.

18. The vegetable food product according to claim 3, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally, up to 15% of at least one vegetable ingredient, including a vegetable protein concentrate or isolate or inclusions;
up to 15% of at least one source of starch;
optionally, up to 8% of vegetable food fibres;
optionally, up to 5% of other ingredients, including aromas, a source of sugars, or a source of calcium; and
between 45% and 85% of water.

19. The vegetable food product according to claim 4, prepared from the following ingredients (percentages expressed by weight based on the total weight of the product):
5 to 40% of crushed nuts; the nut particles are less than or equal to 50 μm in size;
optionally, up to 20% of vegetable fat;
up to 1.5% of food salt;
from 0.01 to 0.5% of lactic ferments and optionally refining ferments;
optionally, up to 15% of at least one vegetable ingredient, including a vegetable protein concentrate or isolate or inclusions;
up to 15% of at least one source of starch;
optionally, up to 8% of vegetable food fibres;
optionally, up to 5% of other ingredients, including aromas, a source of sugars, or a source of calcium; and
between 45% and 85% of water.

20. The vegetable food product according to claim 2, comprising (percentages expressed by weight with respect to the total weight of the product):
5 to 52% of crushed nuts; the nut particles are less than or equal to 50 μm in size;
optionally, up to 26% of vegetable fat;
0.5 to 2.5% of food salt;
optionally up to 20% of a vegetable ingredient, including a vegetable protein concentrate or isolate or inclusions;
optionally, up to 20% of at least one source of starch;
optionally up to 10% of vegetable food fibres;
optionally up to 7% of other ingredients, including aromas, sugar or calcium sources; and
between 35% and 75% of water.
